(19) United States
(12) Patent Application Publication
(10) Pub. No.: US 2025/0388810 A1
(43) Pub. Date: Dec. 25, 2025

(54) Kit for Sustaining Luminescence of Luminescent Substrate and Method for Sustaining Luminescence of Luminescent Substrate

(71) Applicant: SHIMADZU CORPORATION, Kyoto-shi (JP)

(72) Inventor: Yuki OHMURO, Kyoto-shi (JP)

(73) Assignee: SHIMADZU CORPORATION, Kyoto-shi (JP)

(21) Appl. No.: 19/242,935

(22) Filed: Jun. 18, 2025

(30) Foreign Application Priority Data
Jun. 21, 2024 (JP) 2024-100442

(51) Int. Cl. C09K 11/06; G01N 1/30

(52) U.S. Cl. CPC C09K 11/06; G01N 1/30; C09K 2211/1044

(57) ABSTRACT

A kit for sustaining luminescence of a luminescent substrate, the kit comprising a surfactant and an alcohol, wherein the luminescent substrate is a hydrophobic compound, and a molecular weight of the luminescent substrate is 300 or more and 500 or less.

### CROSS REFERENCE TO RELATED APPLICATIONS

This nonprovisional application is based on Japanese Patent Application No. 2024-100442 filed on Jun. 21, 2024 with the Japan Patent Office, the entire contents of which are hereby incorporated by reference.

### BACKGROUND OF THE INVENTION

### Field of the Invention

The present invention relates to a kit for sustaining luminescence of a luminescent substrate and a method for sustaining luminescence of a luminescent substrate.

### Description of the Background Art

In the field of basic biology and the field of diagnostic technology and testing technology, an approach, in which a reporter substance is fused to a target substance or a protein (for example, antibody) that specifically binds to the target substance in order to detect the target substance (for example, protein and an antigen), is known. As the reporter substance, a luminescent enzyme, a fluorescent protein, a fluorescent dye, a quantum dot, and peroxidase are known. For example, Japanese Patent Laying-Open No. 2022-123828 discloses a polypeptide that has luminescent enzyme activity and contains a predetermined amino acid sequence.

### SUMMARY OF THE INVENTION

Although the luminescence by a luminescent enzyme has a lower luminescence intensity than when a fluorescent protein, a fluorescent dye, or a quantum dot is used as a reporter substance, it does not require excitation light. Therefore, it is not phototoxic to cells and is suitable for detecting trace amounts.

However, the reaction between a luminescent enzyme and a luminescent substrate (may be referred to as a “luminescence reaction”) generally exhibits a luminescence pattern in which the maximum luminescence intensity is reached immediately after the reaction and then the luminescence intensity rapidly decays. Therefore, a method for improving the luminescence sustainability is required.

The present invention was made in consideration of the above circumstances, and has an object to provide a kit for sustaining luminescence of a luminescent substrate and a method for sustaining luminescence of a luminescent substrate, which can improve the luminescence sustainability.

As a result of intensive studies, the inventors have found that the luminescence sustainability is improved when a luminescent enzyme and a luminescent substrate are allowed to react in the presence of a surfactant and an alcohol, and completed the present invention.

A first aspect of the present invention relates to a kit for sustaining luminescence of a luminescent substrate, the kit comprising:
a surfactant; and
an alcohol,
wherein the luminescent substrate is a hydrophobic compound, and
a molecular weight of the luminescent substrate is 300 or more and 500 or less.

A second aspect of the present invention relates to a method for sustaining luminescence of a luminescent substrate, the method comprising:
a preparation step of preparing a luminescent substrate and a luminescent enzyme; and
a reaction step of allowing the luminescent substrate and the luminescent enzyme to react,
wherein the luminescent substrate is a hydrophobic compound,
a molecular weight of the luminescent substrate is 300 or more and 500 or less, and
the reaction step is performed in the presence of a surfactant and an alcohol.

According to the present invention, it is possible to provide a kit for sustaining luminescence of a luminescent substrate and a method for sustaining luminescence of a luminescent substrate, which can improve the luminescence sustainability.

### BRIEF DESCRIPTION OF THE DRAWINGS

FIG. 1 is (A) graphs showing a change in luminescence intensity over time, (B) graphs showing the correlation between the maximum value of the normalized luminescence intensity (vertical axis) and the concentration of the luminescent enzyme and the concentration of the surfactant (horizontal axis), and (C) graphs showing the correlation between the half-life of the luminescence reaction (horizontal axis) and the concentration of the luminescent enzyme and the concentration of the surfactant (vertical axis), in Experiment 1. In FIG. 1A, the horizontal axis shows the elapsed time immediately after the enzyme solution and the substrate solution are mixed, and the vertical axis shows a relative light unit per second.

FIG. 2 is (A) graphs showing the correlation between the maximum value of the normalized luminescence intensity (vertical axis) and the concentration of the luminescent enzyme and the concentration of the surfactant (horizontal axis), and (B) graphs showing the correlation between the half-life of the luminescence reaction (horizontal axis) and the concentration of the luminescent enzyme and the concentration of the surfactant (vertical axis), in Experiment 1.

FIG. 3 is (A) graphs showing a change in luminescence intensity over time, (B) graphs showing the correlation between the maximum value of the normalized luminescence intensity (vertical axis) and the concentration of the luminescent enzyme and the concentration of the surfactant (horizontal axis), and (C) graphs showing the correlation between the half-life of the luminescence reaction (horizontal axis) and the concentration of the luminescent enzyme and the concentration of the surfactant (vertical axis), in Experiment 2. In FIG. 3A, the horizontal axis shows the elapsed time immediately after the enzyme solution and the substrate solution are mixed, and the vertical axis shows a relative light unit per second.

FIG. 4 is a graph showing a change in luminescence intensity over time in Experiment 3. In FIG. 4, the horizontal axis shows the elapsed time immediately after the enzyme solution and the substrate solution are mixed, and the vertical axis shows a relative light unit per second.

FIG. 5 is a schematic view for explaining a general detection system using biotin and streptavidin.

FIG. 6 is (A) a schematic view of a simulated detection system, (B) a graph showing a change in luminescence intensity over time, (C) a graph showing the correlation between the maximum value of the relative light unit (vertical axis) and the concentration of the surfactant (horizontal axis), and (D) a graph showing the correlation between the integrated value of the relative light unit (vertical axis) and the concentration of the surfactant (horizontal axis), in Experiment 4. In FIG. 6B, the horizontal axis shows the elapsed time immediately after the enzyme solution and the substrate solution are mixed, and the vertical axis shows a relative light unit per second.

FIG. 7 is graphs showing the measurement results by the dynamic light scattering method in Experiment 5. In FIG. 7, the horizontal axis shows the size of the detected particles, and the vertical axis shows the distribution rate.

FIG. 8 is photographs of the particles in Experiment 6 observed with a microscope.

FIG. 9 is a graph showing a change in luminescence intensity over time in Experiment 6. In FIG. 9, the horizontal axis shows the elapsed time immediately after the enzyme solution and the substrate solution are mixed, and the vertical axis shows a relative light unit per second.

FIG. 10 is (A) graphs showing the correlation between the relative light unit (vertical axis) and the presence or absence of the surfactant and the substrate metabolites (horizontal axis), and (B) graphs showing the relationship between the rate of decrease in the amount of luminescence due to the addition of the substrate metabolites (vertical axis) and the presence or absence of the surfactant (horizontal axis), in Experiment 7.

FIG. 11 is graphs showing a change in the luminescent substrate and metabolites of the luminescent substrate in the reaction solution over time in Experiment 8. The vertical axis shows the concentration of the compound to be analyzed, and the horizontal axis shows the presence or absence of the luminescent enzyme and the surfactant, and the elapsed time from the start of the reaction.

FIG. 12 is graphs showing a change in the luminescent substrate and metabolites of the luminescent substrate in the reaction solution over time in Experiment 8. The vertical axis shows a relative change in the concentration of the compound to be analyzed, and the horizontal axis shows the presence or absence of the surfactant, and the elapsed time from the start of the reaction.

### DESCRIPTION OF THE PREFERRED EMBODIMENTS

Hereinafter, one embodiment of the present invention (hereinafter referred to as “this embodiment”) will be described. However, this embodiment is not limited thereto. As used in the present specification, the expression of the format “A to Z” means the upper limit and the lower limit of the range (that is, A or more and Z or less), and when no unit is written in A and a unit is only written in Z, the unit for A and the unit for Z are the same.

### <<Kit for Sustaining Luminescence of Luminescent Substrate>>

The first aspect of the present invention is a kit for sustaining luminescence of a luminescent substrate, the kit comprising:
a surfactant; and
an alcohol,
wherein the luminescent substrate is a hydrophobic compound, and
a molecular weight of the luminescent substrate is 300 or more and 500 or less.

### <Surfactant>

In this embodiment, the “surfactant” means a compound including both a portion that has affinity to water (hydrophilicity) and a portion that has affinity to a nonpolar solvent in a molecule. Examples of the surfactant include anionic surfactants, cationic surfactants, amphoteric surfactants, and nonionic surfactants. In this embodiment, the surfactant preferably includes a nonionic surfactant or an amphoteric surfactant.

Examples of the nonionic surfactant include NP-40 (poly(oxyethylene)=octylphenyl ether), Tween 20 (polyoxyethylene (20) sorbitan monolaurate), Triton X-100 (polyoxyethylene (10) octylphenyl ether), n-octyl-β-D-thioglucoside, and MEGA-8 (n-octanoyl-N-methyl-D-glucamine). Examples of the amphoteric surfactant include CHAPS (3-[(3-cholamidopropyl dimethylammonio]propanesulfonate).

In one aspect of this embodiment, the surfactant preferably contains at least one selected from the group consisting of NP-40, CHAPS, Tween 20, Triton X-100, n-octyl-β-D-thioglucoside, and MEGA-8.

In this embodiment, the surfactant may be contained alone in a container, or may be contained in a container in the form of an aqueous solution. The surfactant may also be contained in the same container together with other components such as an alcohol that will be described later. In one aspect of this embodiment, when the surfactant is in the form of an aqueous solution, the concentration of the surfactant may be, for example, 0.0001% by mass or more and 20% by mass or less, or 0.001% by mass or more and 5% by mass or less.

### <Alcohol>

In this embodiment, the “alcohol” means a compound obtained by replacing a hydrogen atom of an aliphatic hydrocarbon with a hydroxyl group (—OH). Examples of the alcohol include saturated aliphatic alcohols having 1 to 4 carbon atoms. The alcohol may be a primary alcohol, may be a secondary alcohol, or may be a tertiary alcohol, but is preferably a primary alcohol. In this embodiment, the alcohol preferably includes at least one selected from the group consisting of ethanol, methanol, propanol, isopropanol, and butanol.

In this embodiment, the alcohol may be contained alone in a container, or may be contained in the same container together with the surfactant and other components such as the luminescent substrate that will be described later. In one aspect of this embodiment, the surfactant and the alcohol may be contained in separate containers. In another aspect of this embodiment, the surfactant and the alcohol may be contained in the same container.

### <Luminescent Substrate>

The luminescent substrate to be used in the kit for sustaining luminescence according to this embodiment is a hydrophobic compound. When the luminescent substrate is a hydrophobic compound, the luminescent substrate accumulates in the micelle particles formed by the surfactant and the alcohol, and thus the luminescence sustainability is improved. In one aspect of this embodiment, the luminescent substrate may be fused with other compounds such as a fluorescent dye.

The molecular weight of the luminescent substrate is 377 or more and 423 or less, may be 300 or more and 376 or less, or may be 424 or more and 500 or less.

In this embodiment, examples of the luminescent substrate include known luminescent substrates such as coelenterazine-based (cypridina luciferin-based) furimazine. Examples of the coelenterazine-based substrate include natural coelenterazine (nCTZ), coelenterazine ip, coelenterazine i, coelenterazine hcp, coelenterazine 400A, coelenterazine, coelenterazine cp, coelenterazine f, and coelenterazine h (CTZh).

In one aspect of this embodiment, the luminescent substrate preferably contains at least one selected from the group consisting of coelenterazines and coelenterazine analogs.

In this embodiment, the luminescent substrate may or may not be included as a reagent constituting the kit for sustaining luminescence. In other words, the kit for sustaining luminescence may further include the luminescent substrate. The luminescent substrate may be contained alone in a container, or may be contained in the state of being dissolved in an alcohol. The luminescent substrate may also be contained in the same container together with other components.

### <Others>

In one aspect of this embodiment, the kit for sustaining luminescence may further include one or more selected from the group consisting of a luminescent enzyme, a buffer solution, a sample tube, a microplate, an instruction manual for a kit user, and a luminescent substrate. The instruction manual describes, for example, the procedure of a method for sustaining luminescence of a luminescent substrate according to the second aspect that will be described below.

### <Luminescent Enzyme>

In this embodiment, the luminescent enzyme contained in the kit for sustaining luminescence is not particularly limited as long as it is a luminescent enzyme that catalyzes the luminescence reaction of the luminescent substrate. Examples of the luminescent enzyme include Renilla luciferase (RLuc), copepod luciferase (GLuc), NanoLuc (registered trademark) (modified form of luciferase derived from Oplophorus gracilirostris), ALuc (registered trademark) (modified form of GLuc), and picALuc (registered trademark) (modified form of GLuc). The above-mentioned luminescent enzyme may be produced by a known method or may be purchased as a commercially available product. For example, picALuc (registered trademark) can be produced by the method disclosed in Japanese Patent Laying-Open No. 2022-123828.

The luminescent enzyme may be contained alone in a container, or may be contained in the state of being dissolved in a buffer solution. The luminescent enzyme may also be contained in the same container together with other components such as the surfactant.

### <<Method for Sustaining Luminescence of Luminescent Substrate>>

The second aspect of the present invention is a method for sustaining luminescence of a luminescent substrate, the method comprising:
a preparation step of preparing a luminescent substrate and a luminescent enzyme; and
a reaction step of allowing the luminescent substrate and the luminescent enzyme to react,
wherein the luminescent substrate is a hydrophobic compound,
a molecular weight of the luminescent substrate is 300 or more and 500 or less, and
the reaction step is performed in the presence of a surfactant and an alcohol.

In one aspect of this embodiment, the method for sustaining luminescence of a luminescent substrate may be performed using the kit for sustaining luminescence according to the first aspect described above.

### <Preparation Step>

In this step, a luminescent substrate and a luminescent enzyme are prepared. The luminescent substrate is a hydrophobic compound. The molecular weight of the luminescent substrate is 300 or more and 500 or less. The respective specific examples of the luminescent substrate and the luminescent enzyme are as described above. The luminescent substrate may be prepared alone or may be prepared in the state of being dissolved in, for example, an alcohol. The luminescent enzyme may be prepared alone or may be prepared in the state of being dissolved in, for example, a buffer solution.

In one aspect of this embodiment, the preparation step may include preparing a substrate solution containing the luminescent substrate and the alcohol and an enzyme solution containing the luminescent enzyme and the surfactant.

### <Reaction Step>

In this step, the luminescent substrate and the luminescent enzyme are allowed to react. The reaction step is performed in the presence of a surfactant and an alcohol. The respective specific examples of the surfactant and the alcohol are as described above.

In one aspect of this embodiment, the reaction step is preferably performed in the presence of water, a surfactant, and an alcohol.

Conventionally, it has been known that the reaction between a luminescent enzyme and a luminescent substrate generally exhibits a luminescence pattern, in which the maximum luminescence intensity is shown immediately after the reaction, and then the luminescence intensity rapidly decays. As a result of intensive studies, the present inventors have found for the first time that the luminescence sustainability is improved when a luminescent enzyme and a luminescent substrate are allowed to react in the presence of a surfactant and an alcohol. The present inventors believe that a surfactant and an alcohol allow the surfactant to form micelle particles in the reaction system, and the luminescent substrate (hydrophobic compound) accumulates on the particles, which contributes to sustaining luminescence. In addition, based on this mechanism, the present inventors believe that the luminescence sustainability is improved without depending on the type of luminescent enzyme.

In the preparation step, when the substrate solution and the enzyme solution are prepared, the reaction step preferably includes mixing the substrate solution and the enzyme solution. Hereinafter, the solution obtained by mixing the substrate solution and the enzyme solution is described as the “reaction solution”.

In this embodiment, the concentration of the luminescent substrate in the reaction solution is not particularly limited within the range that achieves the effects of the present invention. Examples thereof include the concentrations described in the Examples.

In this embodiment, the concentration of the luminescent enzyme in the reaction solution is not particularly limited within the range that achieves the effects of the present invention. Examples thereof include the concentrations described in the Examples.

In this embodiment, the concentration of the surfactant in the reaction solution is preferably 0.00001% by mass or more and 20% by mass or less, more preferably 0.0001% by mass or more and 10% by mass or less, and still more preferably 0.001% by mass or more and 5% by mass or less.

In this embodiment, the concentration of the alcohol in the reaction solution is preferably 0.001% by volume or more and 10% by volume or less, and more preferably 0.01% by volume or more and 1% by volume or less.

The buffer component, pH, and temperature in the reaction solution are not particularly limited as long as the luminescence reaction by the luminescent enzyme and the luminescent substrate proceeds appropriately, and can be appropriately set. For example, examples of the buffer component include sodium dihydrogen phosphate, disodium hydrogenphosphate, HEPES, and tris(hydroxymethyl)aminomethane. The pH of the reaction solution is, for example, 5.0 or more and 8.0 or less. The temperature of the reaction solution may be, for example, 4° C. or more and 40° C. or less, may be 4° C. or more and 37° C. or less, or may be 4° C. or more and 30° C. or less.

### <Other Steps>

The method for sustaining luminescence of a luminescent substrate according to this embodiment may further include other steps in addition to the preparation step and the reaction step. Examples of the other steps include a detection step of detecting the light emitted by allowing the luminescent substrate and the luminescent enzyme to react using a spectrophotometer, and an observation step of observation with a microscope or visual observation.

### EXAMPLES

Hereinafter, the present invention will be described in more detail by way of Examples, but the present invention is not limited thereto.

### Experiment 1: Influence of Surfactant on Luminescence Characteristics

When a luminescent enzyme and a luminescent substrate were allowed to react in the presence of a surfactant and an alcohol, how the luminescence characteristics of the luminescent substrate change was examined. First, the luminescent enzyme and the surfactant described below were diluted in a buffer (137 mM NaCl, 9.6 mM KH₂PO₄, 2.7 mM KCl, pH 7.0) to obtain an enzyme solution with different concentrations of the luminescent enzyme and the surfactant.

### (Luminescent Enzyme)

Name of luminescent enzyme: picALuc (product name, manufactured by SHIMADZU CORPORATION)

Final concentration of luminescent enzyme: 1 nM to 100 nM

### (Surfactant)

Name of surfactant: NP-40, CHAPS, Tween 20, Triton X-100, n-octyl-β-D-thioglucoside, or MEGA-8

Final concentration of surfactant: 0 to 5%

Also, coelenterazine h (CTZh), which is the luminescent substrate, was dissolved in ethanol (EtOH) so that a final concentration thereof was 2.4 mM, to obtain an ethanol solution of CTZh. The obtained ethanol solution was further diluted 1000-folds with the above buffer to obtain a substrate solution (final concentration of CTZh: 2.4 μM).

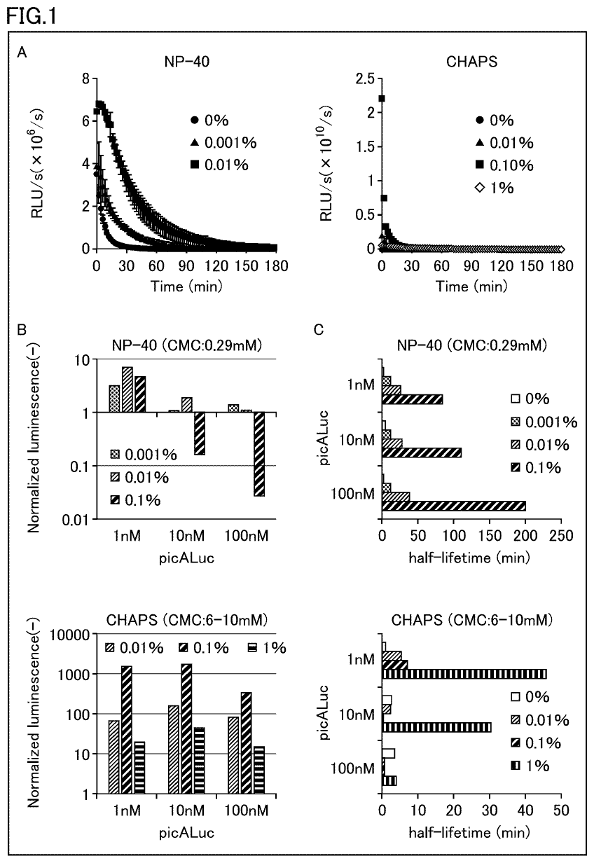

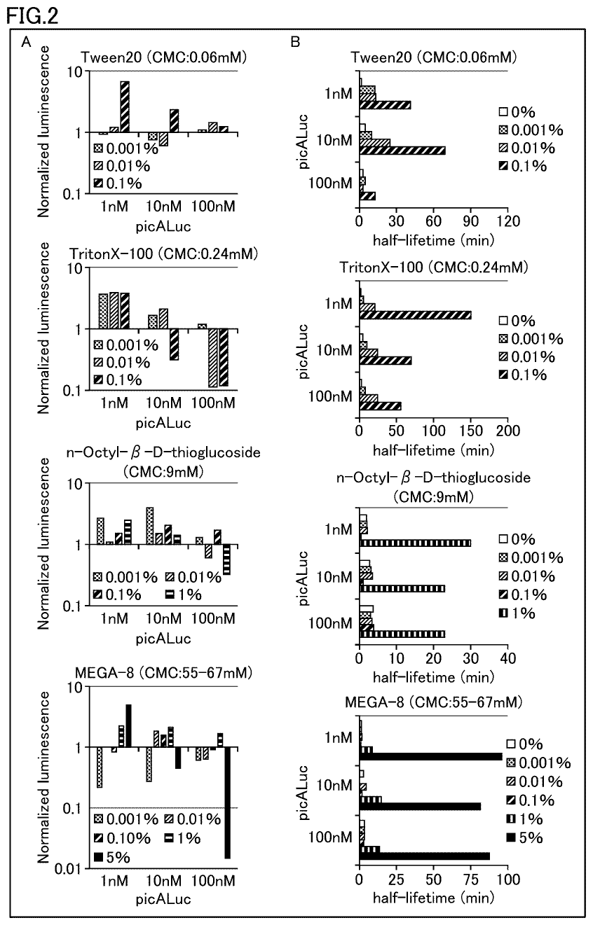

Then, 50 μL of the enzyme solution and 50 μL of the substrate solution were mixed. The luminescence value was measured immediately after mixing. At this time, as the measurement device, GloMax (registered trademark) Navigator Microplate Luminometer (manufactured by Promega) was used. The results are shown in FIG. 1 and FIG. 2. FIG. 1A is graphs showing a change in luminescence intensity over time. In FIG. 1A, the horizontal axis shows the elapsed time immediately after the enzyme solution and the substrate solution are mixed, and the vertical axis shows a relative light unit per second. FIG. 1B is graphs showing the correlation between the maximum value of the normalized luminescence intensity (vertical axis) and the concentration of the luminescent enzyme and the concentration of the surfactant (horizontal axis). FIG. 1C is graphs showing the correlation between the half-life of the luminescence reaction (horizontal axis) and the concentration of the luminescent enzyme and the concentration of the surfactant (vertical axis). FIG. 2A is graphs showing the correlation between the maximum value of the normalized luminescence intensity (vertical axis) and the concentration of the luminescent enzyme and the concentration of the surfactant (horizontal axis). FIG. 2B is graphs showing the correlation between the half-life of the luminescence reaction (horizontal axis) and the concentration of the luminescent enzyme and the concentration of the surfactant (vertical axis).

From the results of FIG. 1C and FIG. 2B, it was found that the half-life of the luminescence reaction was longer depending on the concentration of the surfactant added. Furthermore, from these results and the results of Experiment 5 described later, it was suggested that the luminescence of the luminescent substrate was sustained in the presence of a surfactant and an alcohol. Furthermore, from the results of FIG. 1B and FIG. 2A, it was found that depending on the concentration of the luminescent enzyme (for example, 1 nM) and the type of surfactant (for example, NP-40, CHAPS, and the like), enhancement of the luminescence intensity was also observed in addition to sustained luminescence.

### Experiment 2: Dependence of Kind of Luminescent Enzyme

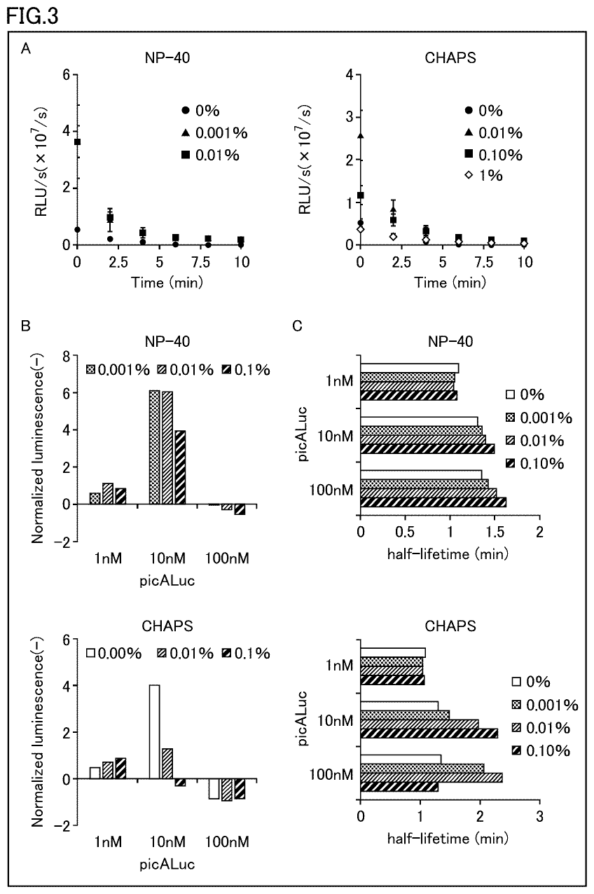

The experiment was performed in the same manner as in Experiment 1 except that NanoLuc (manufactured by Promega) was used as a luminescent enzyme and NP-40 or CHAPS was used as a surfactant. The results are shown in FIG. 3. FIG. 3A is graphs showing a change in luminescence intensity over time. In FIG. 3A, the horizontal axis shows the elapsed time immediately after the enzyme solution and the substrate solution are mixed, and the vertical axis shows a relative light unit per second. FIG. 3B is graphs showing the correlation between the maximum value of the normalized luminescence intensity (vertical axis) and the concentration of the luminescent enzyme and the concentration of the surfactant (horizontal axis). FIG. 3C is graphs showing the correlation between the half-life of the luminescence reaction (horizontal axis) and the concentration of the luminescent enzyme and the concentration of the surfactant (vertical axis). From the results of FIG. 3C, it was found that the half-life of the luminescence reaction was longer depending on the concentration of the surfactant added even when NanoLuc was used as a luminescent enzyme. From the results, it was suggested that sustained luminescence in the presence of a surfactant and an alcohol does not depend on the kind of luminescent enzyme. In addition, from the results of FIG. 3B, it was found that depending on the concentration of the luminescent enzyme (for example, 10 nM) and the type of surfactant (for example, NP-40, CHAPS, and the like), enhancement of the luminescence intensity was also observed in addition to sustained luminescence even when NanoLuc was used as a luminescent enzyme.

### Experiment 3: Dependence of Alcohol and Luminescent Substrate

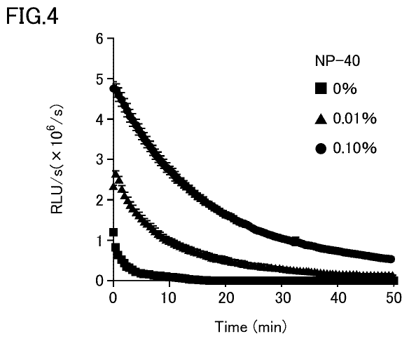

The experiment was performed in the same manner as in Experiment 1 except that methanol (MeOH) manufactured by FUJIFILM Wako Pure Chemical Corporation) was used as an alcohol, NP-40 was used as a surfactant, and native coelenterazine (nCTZ, final concentration 8 μM) (manufactured by FUJIFILM Wako Pure Chemical Corporation) was used as a luminescent substrate. At this time, the final concentration of the luminescent enzyme (picALuc) was set to 100 nM. The results are shown in FIG. 4. FIG. 4 is a graph showing a change in luminescence intensity over time. In FIG. 4, the horizontal axis shows the elapsed time immediately after the enzyme solution and the substrate solution are mixed, and the vertical axis shows a relative light unit per second. From the results of FIG. 4, it was found that sustained luminescence and enhancement of the luminescence intensity were observed even when methanol was used as an alcohol and nCTZ was used as a luminescent substrate.

### Experiment 4: Examination of Usefulness in Detecting Target Substance

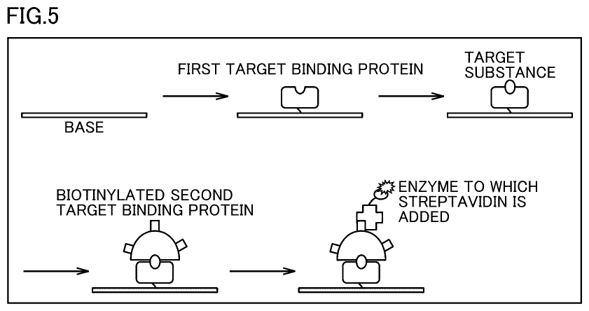

Whether the use of a surfactant was useful in detecting a target substance was confirmed. In a detection system such as ELISA (Enzyme-linked Immunosorbent Assay) (herein, including the case where a target binding protein other than an antibody is used), a first target binding protein is immobilized on a base, and a solution that may contain a target substance is added thereto. Next, in order to detect the target substance bound to the first target binding protein on the base, a biotinylated second target binding protein is added thereto, and an enzyme, fluorescent dye, or the like to which streptavidin is added is bound to the biotin. As described above, the target substance is detected by the enzyme, the fluorescent dye, or the like (for example, FIG. 5).

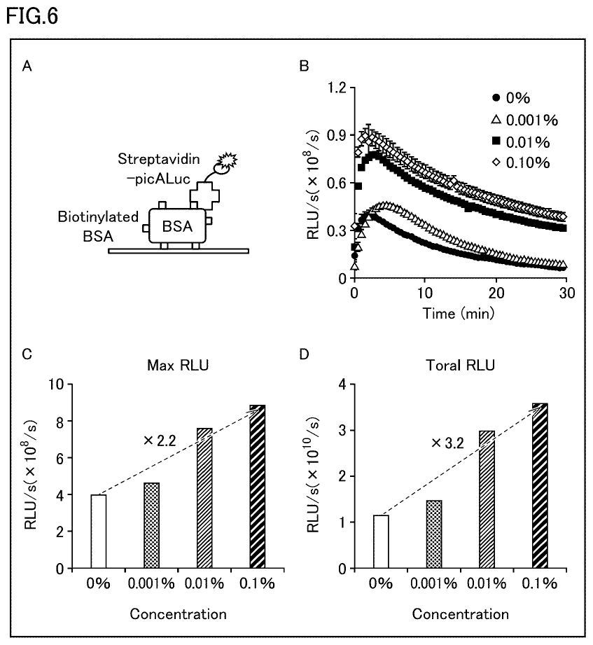

In this experiment, as a simulated detection system, biotinylated bovine serum albumin (BSA) was immobilized on a base of a 96-well plate and detection was performed using streptavidin-fused picALuc (FIG. 6A). Specifically, 100 μL of a biotinylated BSA solution (final concentration 10 μg/mL) was first added to each well. After each well was washed with a washing buffer (PBST (0.1% Tween)), blocking was performed by addition of 200 μL of a blocking buffer (20% Immnoblock (manufactured by KAC Co., ltd.) in PBS) to each well. After each well was washed with a washing buffer again, 100 μL of a streptavidin-fused picALuc solution (final concentration 1 μg/mL, diluted with 5% Immunoblock in PBST) was added to each well. Each well was washed with a washing buffer.

Then, immediately before the luminescent substrate was added, NP-40 was diluted with a buffer (PBS) so that the final concentration was 0.002 to 0.2%, and 100 μL of the resulting diluted solution was added to each well. Next, 100 μL of the substrate solution prepared in the same manner as in Experiment 1 was added to each well. The luminescence value was measured immediately after the substrate solution was added. At this time, as the measurement device, GloMax (registered trademark) Navigator Microplate Luminometer (manufactured by Promega) was used. The results are shown in FIG. 6. FIG. 6B is a graph showing a change in luminescence intensity over time. In FIG. 6B, the horizontal axis shows the elapsed time immediately after the substrate solution is added to wells, and the vertical axis shows a relative light unit per second. FIG. 6C is a graph showing the correlation between the maximum value of the relative light unit (vertical axis) and the concentration of the surfactant (horizontal axis). FIG. 6D is a graph showing the correlation between the integrated value of the relative light unit (vertical axis) and the concentration of the surfactant (horizontal axis). The integrated value is the integrated value obtained for 30 minutes after the addition of the substrate solution.

From the results of FIG. 6, an increase in the maximum value of the relative light unit and the sustained luminescence were observed dependently on the concentration of NP-40 (FIG. 6B). Since the addition of NP-40 increases the luminescence sustainability, when 0.1% NP-40 was added, the maximum value of the relative light unit was 2.2 times higher than when NP-40 was not added (FIG. 6C), while the integrated value of the relative light unit was 3.2 times (FIG. 6D). As described above, it was suggested that even in the above simulated detection system, the luminescence of the luminescent substrate was sustained and the luminescence value increased in the presence of a surfactant and an alcohol.

### Experiment 5: Micelle Formation of Surfactant

From the results of Experiment 1, the concentration of a surfactant at which sustained luminescence is observed tends to be higher as the critical micelle concentration (CMC) of the surfactant is higher (FIGS. 1 and 2). Therefore, considering the possibility that particles such as micelles were formed in the reaction system of Experiment 1, measurement was made using the dynamic light scattering method with the measurement samples and the measurement conditions described below.

### (Composition of Measurement Sample)

NP-40 (final concentration 0.01%)

picALuc (final concentration 10 nM)

CTZh (final concentration 2.4 μM)

EtOH (final concentration 0.05%)

Buffer (137 mM NaCl, 9.6 mM KH₂PO₄, 2.7 mM KCl, pH 7.0, remainder)

### (Measurement Conditions)

Measurement device: ELSZ-2000 (manufactured by Otsuka Electronics Co., Ltd.)

Measurement temperature: room temperature

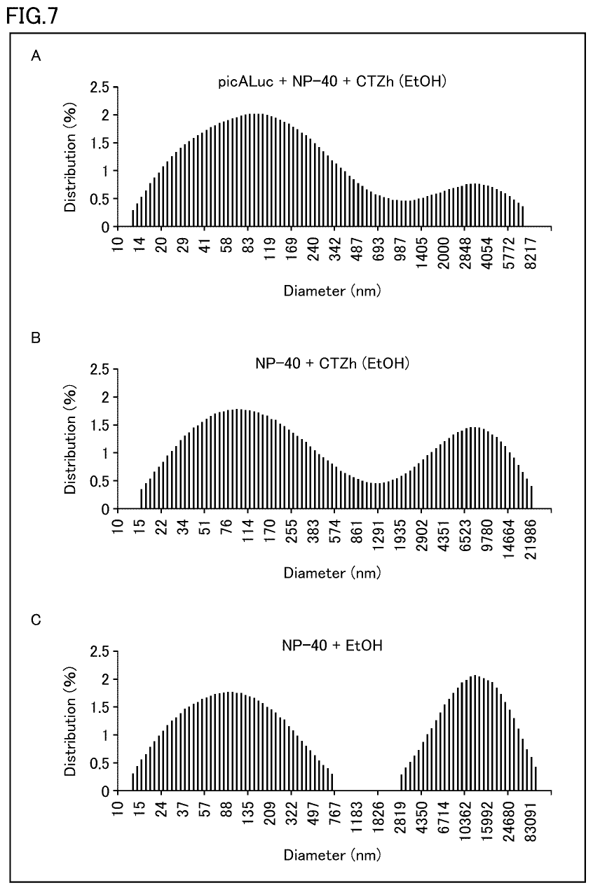

As a result, a signal indicating the presence of particles was observed in a mixture solution of CTZh dissolved in a buffer containing picALuc, NP-40, and EtOH (FIG. 7A). In order to clarify the cause of particle formation, the components of the measurement sample used were removed and the same measurement was performed. After picALuc was removed from the measurement sample, a signal was observed in a buffer containing NP-40 and EtOH (FIG. 7B). This result showed that picALuc was not involved in particle formation. In addition to picALuc, EtOH was further removed from the measurement sample, and a signal was not observed in a mixture solution of CTZh dissolved in a buffer containing only NP-40. Note that, a signal indicating the presence of particles was observed when a buffer containing only NP-40 and EtOH (a buffer in which CTZh is not dissolved) was measured (FIG. 7C). From the above results, it was suggested that a surfactant and an alcohol are necessary to form the above particles.

### Experiment 6: Microscopic Observation of Particles

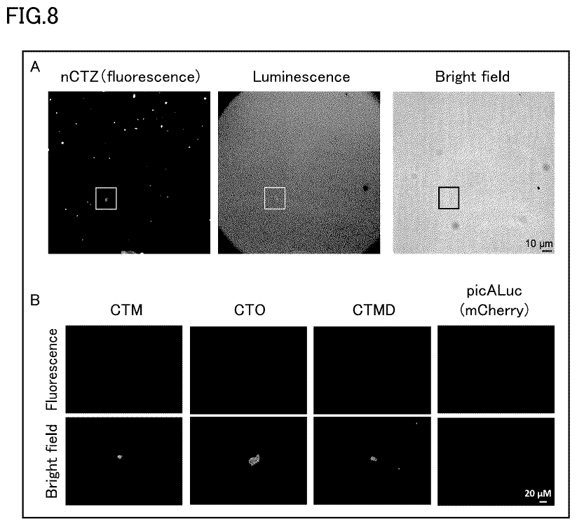

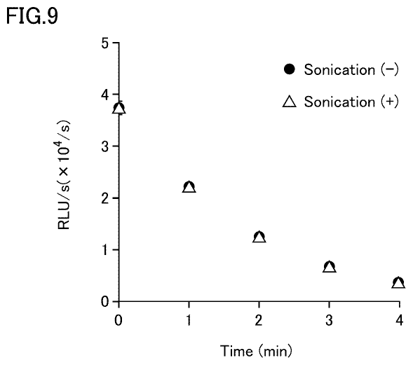

When particles (micelles of NP-40) in a mixture solution of nCTZ and picALuc diluted with ethanol were observed using a microscope (product name IX83, manufactured by Olympus Corporation) and an EM CCS camera (product name iXon Ultra888, Andor Technology), particles having various shapes and sizes were observed (FIG. 8). Among these, the position of the large particles corresponded to the position of the fluorescence of nCTZ and the position of the luminescence due to the reaction between picALuc and nCTZ (FIG. 8A). When ultrasonic waves were applied to the mixture solution, small particles were observed, but large particles were hardly observed. On the other hand, since there was no change in the luminescence pattern before and after the ultrasonic treatment (FIG. 9), the following two possibilities are considered: i) the possibility that the signal localized to the particles accumulated in the larger particles, reaching a signal level that could be detected by a microscope, and luminescence also occurs even on small particles, or ii) the possibility that particle formation is not related to the luminescence pattern. However, considering that the concentration of the surfactant at which sustained luminescence is observed tends to be higher as the CMC of the surfactant increases, the possibility i) was considered to be supported.

Furthermore, coelenteramine (CTM) that is a non-luminescent metabolite of nCTZ, 3-benzyl-5-(4-hydroxyphenyl) pyrazin-2 (1H)-one (CTO) that is an oxide of nCTZ, and coelenteramide (CTMD) that is a luminescent metabolite of nCTZ were each diluted in MeOH, mixed with NP-40, and observed under a microscope (product name BZ-X810, manufactured by KEYENCE CORPORATION). As a result, the fluorescence of CTM, CTO, and CTMD corresponded to the position of the large particles. In addition, in a mixture solution of mCherry-fused picALuc, MeOH, and NP-40, the position of mCherry fluorescence corresponded to the position of the large particles (FIG. 8B). These results suggested i) the possibility that the luminescence reaction occurs on the particle film, and ii) the possibility that nCTZ, CTM, CTO, and CTMD, which are highly hydrophobic, are easily captured by the particles.

### Experiment 7: Verification of Suppressive Effect of Surfactant on Inhibition of Luminescence Reaction of Substrate Metabolites

It is believed that CTM, CTO, and CTMD each have a structure similar to that of the luminescent substrate (nCTZ), and therefore possibly inhibit the luminescence reaction. For example, it has been reported that substrate metabolites inhibit the luminescence reaction of RLuc. Therefore, the possibility that addition of a surfactant suppresses the inhibition of the luminescence reaction and sustains luminescence was verified.

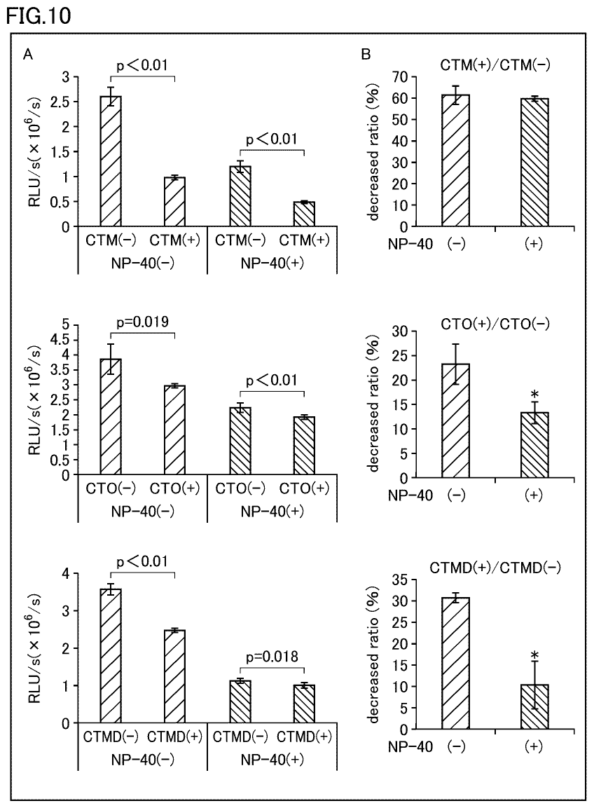

CTM, CTO, or CTMD was added to a mixture solution having the composition described below so that a final concentration was 0 M or 1 μM, followed by incubation at room temperature for 60 minutes. The luminescence value was then measured. At this time, as the measurement device, a GloMax (registered trademark) Navigator Microplate Luminometer (manufactured by Promega) was used. The time indicating the maximum luminescence value (time from addition of the substrate) varies greatly depending on each condition. Therefore, in this experiment, the luminescence value immediately after the addition of the substrate was compared, rather than the maximum luminescence value, so that the amount of the substrate consumed due to the luminescence reaction and the amount of the substrate oxidation due to elapsed time were not taken into consideration. The results are shown in FIG. 10. FIG. 10A is graphs showing the correlation between the relative light unit (vertical axis) and the presence or absence of the surfactant and the substrate metabolites (horizontal axis). FIG. 10B is graphs showing the relationship between the rate of decrease in the amount of luminescence due to the addition of the substrate metabolites (vertical axis) and the presence or absence of the surfactant (horizontal axis).

### (Composition of Mixture Solution)

NP-40 (final concentration 0% or 0.01%)

picALuc (final concentration 100 nM)

nCTZ (final concentration 8 μM)

MeOH (final concentration 0.05%)

Buffer (137 mM NaCl, 9.6 mM KH₂PO₄, 2.7 mM KCl, pH 7.0, remainder)

When NP-40 was not added (NP-40 (−)), a decrease in the luminescence value was observed by addition of CTM, CTO, or CTMD. In particular, when CTM or CTMD was added, the luminescence value significantly decreased (FIG. 10A). On the other hand, when NP-40 was added (NP-40 (+)), a decrease in the luminescence value was clearly observed by addition of CTM, but a decrease in the luminescence value was small by addition of CTO or CTM (FIG. 10A). The decreased ratio in the luminescence value by addition of CTM, CTO, or CTMD was examined when no surfactant was added (NP-40 (−)) and when a surfactant was added (NP-40 (+)) (FIG. 10B). A tendency to suppress the decreased ratio in the luminescence value by addition of CTM was observed by addition of a surfactant, but no significant suppression was observed. On the other hand, a tendency to significantly suppress the decreased ratio in the luminescence value by addition of CTO or CTMD was observed by addition of a surfactant. These results suggested the possibility that, among the inhibition of luminescence reaction caused by CTM, CTO, or CTMD, at least the inhibition of luminescence reaction caused by CTO or CTMD is suppressed by addition of a surfactant, and luminescence is sustained.

### Experiment 8: Examination of Quantitative Ratio of Substrate and Substrate Metabolites in Luminescence Reaction

By LC-MS analysis of a reaction solution containing picALuc and nCTZ, the effect of a surfactant (NP-40) on the amount of the substrate (nCTZ) consumed and the amount of the substrate metabolites (CTM, CTO, CTMD) produced was examined.

A substrate solution (100 μL) having the following composition was added to an enzyme solution (100 μL) having the following composition, to prepare a reaction solution.

(Enzyme solution)

NP-40 (final concentration 0% or 0.01%)

picALuc (final concentration 100 nM)

Buffer (PBS, pH 7.4, remainder)

### (Substrate Solution)

nCTZ (final concentration 8 μM)

MeOH (final concentration 0.05%)

Buffer (PBS, pH 7.4, remainder)

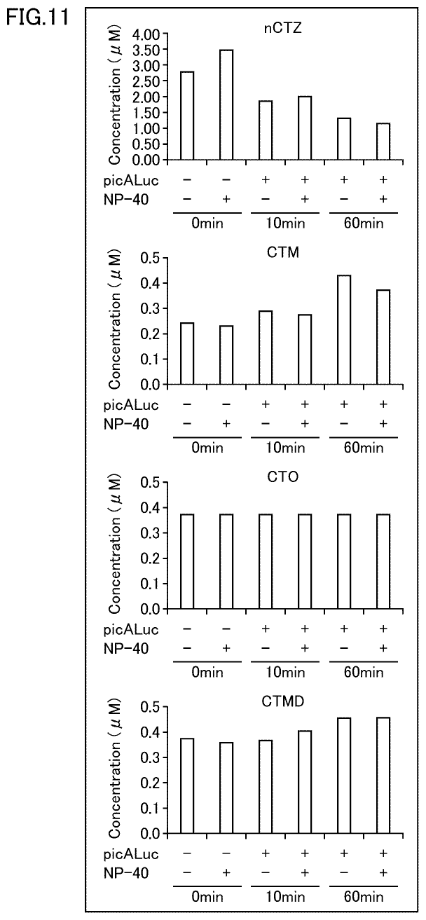

At 0 minutes of the luminescence reaction (before the addition of the substrate solution), 10 minutes after the luminescence reaction, or 60 minutes after the luminescence reaction, 1/1000 (volume ratio) of hydrochloric acid was added to the reaction solution to stop the luminescence reaction, and methanol, which was five times the amount of the reaction solution, was added, followed by centrifugation. Then, the supernatant was collected to remove the luminescent enzyme. After that, each reaction solution was analyzed with an LC-MS device to measure the respective amounts of nCTZ, CTM, CTO, and CTMD (FIG. 11). The measurement conditions at this time are as follows.

### (Measurement Conditions of LC-MS)

### (Measurement Conditions of MS)

Device name: LCMS-8060 (manufactured by SHIMADZU CORPORATION) Measurement mode: multiple reaction monitoring (MRM) mode

Interface temperature: 300° C.

Flow rate of heating gas: 10 L/min

Flow rate of nebulizer gas: 3 L/min

Flow rate of drying gas: 10 L/min

Temperature of desolvation line: 250° C.

Ionization method: electrospray ionization (ESI) source in both positive and negative ion modes

### (LC Measurement Conditions)

Device name: Nexera XS Inert UHPLC (SHIMADZU CORPORATION)

Column used: Wakosil 5C4 column (2.0 mm i.d.×250 mm) (manufactured by FUJIFILM Wako Pure Chemical Corporation)

Mobile phase: 0.1% formic acid (Mobile Phase A)· 0.1% formic acid in acetonitrile (Mobile Phase B)

Flow rate: 0.2 mL/min

Mode: gradient mode

Column temperature: 25° C.

Injection amount: 1 μL

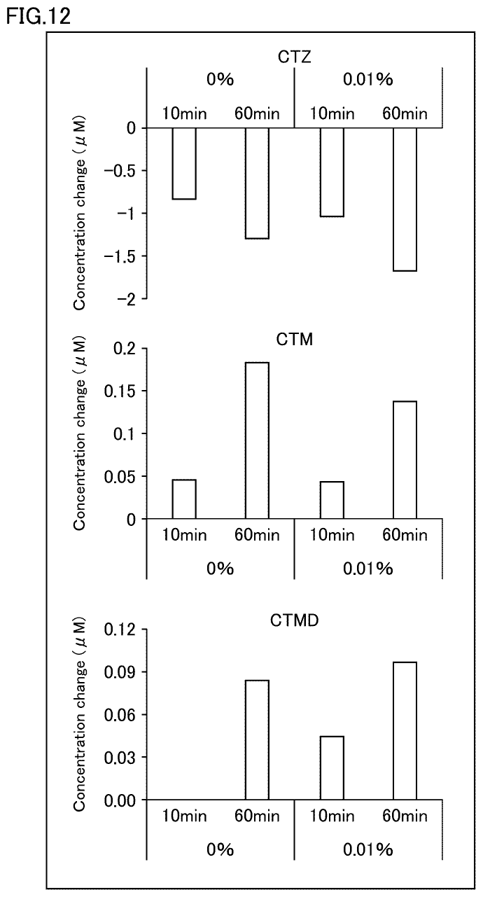

The analysis of nCTZ showed that the amount of nCTZ was different between the case where NP-40 was not added (NP-40 (−)) and the case where NP-40 was added (NP-40 (+)) at 0 minutes of the luminescence reaction (before the addition of the substrate solution). It was thought that the amount of nCTZ was greater than the actual amount when NP-40 was added due to ion effects. Therefore, it was normalized to the amount of nCTZ when NP-40 was not added. Furthermore, the fact that CTM, CTO, and CTMD were already present in the reaction solution at 0 minutes of luminescence reaction is thought to be caused by converting nCTZ to these compounds during storage of nCTZ. Therefore, the amount of nCTZ consumed and the respective amounts of CTM, CTO, and CTMD produced were calculated by subtracting the amount of each component that was present before the reaction (FIG. 12). First, it was found that the amount of nCTZ consumed increased when the surfactant was added. On the other hand, it was found that when the surfactant was added, the amount of CTO produced remained almost unchanged, but the amount of CTM produced decreased, and the amount of CTMD produced increased. An increase in the amount of CTMD produced at the time of addition of the surfactant suggested the possibility that the luminescence value increases.

### Aspects

It will be understood by those skilled in the art that the plurality of exemplary embodiments and Examples described above are specific examples of the following aspects.

(Item 1) A kit for sustaining luminescence of a luminescent substrate according to one aspect is a kit for sustaining luminescence of a luminescent substrate, the kit comprises: a surfactant; and an alcohol, wherein the luminescent substrate is a hydrophobic compound, and a molecular weight of the luminescent substrate is 300 or more and 500 or less. The kit for sustaining luminescence according to Item 1 improves the luminescence sustainability of the luminescent substrate.

(Item 2) In the kit for sustaining luminescence according to Item 1, the surfactant comprises a nonionic surfactant or an amphoteric surfactant. The kit for sustaining luminescence according to Item 2 further improves the luminescence sustainability of the luminescent substrate.

(Item 3) In the kit for sustaining luminescence according to Item 1 or 2, the alcohol comprises at least one selected from the group consisting of ethanol, methanol, propanol, isopropanol, and butanol. The kit for sustaining luminescence according to Item 3 further improves the luminescence sustainability of the luminescent substrate.

(Item 4) In the kit for sustaining luminescence according to any of Items 1 to 3, the luminescent substrate comprises at least one selected from the group consisting of coelenterazines and coelenterazine analogs. The kit for sustaining luminescence according to Item 4 can suitably improve the luminescence sustainability of these luminescent substrates.

(Item 5) In the kits for sustaining luminescence according to Items 1 to 4, the surfactant and the alcohol are contained in separate containers. The kit for sustaining luminescence according to Item 5 can appropriately adjust the formulation ratio between the surfactant and the alcohol.

(Item 6) In the kits for sustaining luminescence according to Items 1 to 4, the surfactant and the alcohol are contained in the same container. The kit for sustaining luminescence according to Item 6 can easily cause luminescence reaction.

(Item 7) In the kits for sustaining luminescence according to Items 1 to 6, the kit further comprises a luminescent enzyme. The kit for sustaining luminescence according to Item 7 can omit preparation of the luminescent enzyme.

(Item 8) A method for sustaining luminescence of a luminescent substrate according to one aspect comprises: a preparation step of preparing a luminescent substrate and a luminescent enzyme; and a reaction step of allowing the luminescent substrate and the luminescent enzyme to react, wherein the luminescent substrate is a hydrophobic compound, a molecular weight of the luminescent substrate is 300 or more and 500 or less, and the reaction step is performed in the presence of a surfactant and an alcohol. The method according to Item 8 improves the luminescence sustainability of the luminescent substrate.

(Item 9) In the method according to Item 8, the preparation step comprises preparing a substrate solution containing the luminescent substrate and the alcohol and an enzyme solution containing the luminescent enzyme and the surfactant, and the reaction step comprises mixing the substrate solution and the enzyme solution. The method according to Item 9 further improves the luminescence sustainability of the luminescent substrate.

The embodiments and Examples of the present invention have been described as above, and it is also planned from the beginning to appropriately combine the configurations of each of the embodiments and each of Examples described above.

The embodiments and Examples disclosed at this time should be considered to be illustrative in all respects and non-limiting. The scope of the present invention is defined by the Claims, not by the above embodiments and Examples, and is intended to include all modifications within the meaning and scope equivalent to the Claims.

What is claimed is:

1. A kit for sustaining luminescence of a luminescent substrate, the kit comprising:
a surfactant; and
an alcohol,
wherein the luminescent substrate is a hydrophobic compound, and
a molecular weight of the luminescent substrate is 300 or more and 500 or less.

2. The kit for sustaining luminescence according to claim 1,
wherein the surfactant comprises a nonionic surfactant or an amphoteric surfactant.

3. The kit for sustaining luminescence according to claim 1,
wherein the alcohol comprises at least one selected from the group consisting of ethanol, methanol, propanol, isopropanol, and butanol.

4. The kit for sustaining luminescence according to claim 1,
wherein the luminescent substrate comprises at least one selected from the group consisting of coelenterazines and coelenterazine analogs.

5. The kit for sustaining luminescence according to claim 1,
wherein the surfactant and the alcohol are contained in separate containers.

6. The kit for sustaining luminescence according to claim 1,
wherein the surfactant and the alcohol are contained in the same container.

7. The kit for sustaining luminescence according to claim 1, further comprising a luminescent enzyme.

8. A method for sustaining luminescence of a luminescent substrate, the method comprising:
a preparation step of preparing a luminescent substrate and a luminescent enzyme; and
a reaction step of allowing the luminescent substrate and the luminescent enzyme to react,
wherein the luminescent substrate is a hydrophobic compound,
a molecular weight of the luminescent substrate is 300 or more and 500 or less, and
the reaction step is performed in the presence of a surfactant and an alcohol.

9. The method according to claim 8,
wherein the preparation step comprises preparing a substrate solution containing the luminescent substrate and the alcohol and an enzyme solution containing the luminescent enzyme and the surfactant, and
the reaction step comprises mixing the substrate solution and the enzyme solution.
